(19) United States
(12) Patent Application Publication
(10) Pub. No.: US 2021/0282336 A1
(43) Pub. Date: Sep. 16, 2021

(54) DEVICE FOR MITIGATING OVERWATERING OF CONTAINER-GROWN PLANTS

(71) Applicants: Cody Paul Lockhart Kupferschmidt, Guelph (CA); Jordan Nicholas Stewart, Ancaster (CA)

(72) Inventors: Cody Paul Lockhart Kupferschmidt, Guelph (CA); Jordan Nicholas Stewart, Ancaster (CA)

(21) Appl. No.: 16/819,005

(22) Filed: Mar. 13, 2020

(51) Int. Cl. A01G 9/04; A01G 9/24

(52) U.S. Cl. CPC A01G 9/047; A01G 9/02; A01G 9/247

(57) ABSTRACT

Provided is a device which can be used to create cavities within the growing media of plant containers to prevent or mitigate against the effects of too much liquid being applied to the growing media. These cavities generally fall into two categories: exfiltration cavities or venting cavities. The exfiltration cavities created by the device allow for the exfiltration of liquid from the growing media of a plant container into the cavities. The venting cavities created by the device provide a space for airflow between the exfiltration cavities and airspace above the growing media in the planting container, so as to facilitate evaporation of the liquid collected in the exfiltration cavity. Also provided is a method for mechanical removal of liquid from the cavities created by the device.

### FIELD OF THE INVENTION

The present invention pertains in general to container gardening. More specifically, the invention pertains to a device that can be placed in the growing media within a plant container to prevent or mitigate the effects of overwatering plants.

### BACKGROUND OF THE INVENTION

When using containers filled with a growing media for rearing plants, an appropriate amount of liquid such as water or a fertilizer solution must be applied to keep the plants alive. The process of applying too much liquid is known as overwatering and can result in negative health impacts to plants including but not limited to root rot, lack of oxygen, and even death of the plant. One current design for preventing overwatering plants uses a container equipped with apertures on the bottom to allow excess water to be discharged through the bottom of the container. There are many disadvantages to this design, since a tray must be placed beneath the container to capture the water, otherwise water damage may occur to whatever is located below the container. Many container designs do not include bottom apertures. A method for preventing overwatering with these types of containers involves the frequent application of small doses of water. Some disadvantages of this method include the time-consuming nature of frequent applications, and the fact that since the soil may not always be fully saturated, plants have a tendency to develop unhealthy, shallow root systems. Additionally, in some plant containers, there is no way to visualize if excess water has been applied and is accumulating in the bottom of the containers.

Other designs exist for preventing overwatering of container grown plants such as incorporating water reservoirs into the container, or using moisture sensors or timers combined with automatic water dispensing systems. The disadvantages of these systems include the need for an electrical power source, high cost, and an inability to retrofit the systems into a wide range of existing containers.

Accordingly, there is a need in the art for a device that can be used to prevent the overwatering of plants and can be used in a wide range of plant containers, including those that do not include a bottom aperture.

### BRIEF SUMMARY OF THE INVENTION

Illustrative embodiments of the invention are generally directed towards a device that can be used to create cavities within the growing media of plant containers, which create an airflow connection to the airspace above the growing media, thus enabling evaporation of water. Within the scope of the present invention, the term “container” refers to any material shaped in a way that it may be filled with a growing media, providing a medium suitable for plant growth. The term “overwatering” is used to refer to the application of any type of liquid at a rate greater than desired to the growing media of a plant container.

The present invention creates at least one cavity located at or near the lowest elevation of the plant container which contains one or more apertures that allow excess liquid applied to the growing media of the container to flow into the cavity. Within the scope of the present invention, this type of cavity is referred to as an “exfiltration cavity.” The present invention also creates one or more cavities which contains one or more apertures at or near its highest elevation to allow airflow between the inside of the cavities and the airspace above the growing media. Within the scope of the present invention, this type of cavity is referred to as a “venting cavity.” The exfiltration and venting cavities are connected via an aperture to allow airflow between the two types of cavities. Together, in the present invention these two types of cavities allow excess liquid applied to the growing media to drain into the exfiltration cavity, which may subsequently be removed via evaporation or mechanical removal.

In some embodiments of the present invention the bottom of the exfiltration cavity is open to the plant container, while in other embodiments the bottom of the exfiltration cavity is closed but may contain one or more apertures. The venting cavities may contain one or more baffles that serve to split the cavity into two or more cavities of equal or unequal geometries to produce separate paths for inflow and outflow of air.

In some embodiments of the present invention the venting cavity may be open on one or more sides, and the cavity is completed by incorporating the wall of the planting container.

The transition from the exfiltration cavity to the venting cavity may be made at varying angles so as to allow the venting cavity to protrude from the surface of the growing media at different locations. This may also be accomplished by the venting cavity being curved to varying degrees or consisting of a flexible material. The transition from the exfiltration cavity to the venting cavity may consist of a flexible connector that allows the venting cavity to be adjusted to varying positions.

The length of the venting cavity may be made adjustable by consisting of two or more pieces that can be connected and disconnected or repositioned to adjust length, such as in a telescoping manner. To prevent the ingress of growing media or plant roots into the cavities, one or more of the apertures on the cavities may be covered with a filter material or screening.

In other embodiments the movement of air through the exfiltration and venting cavities may be augmented by other means. For example, the augmentation of airflow may be accomplished by the use of mechanical ventilation where a device such as an impeller is placed in one or more of the venting cavities, or through use of buoyancy driven ventilation where a device such as a heating element is placed in one or more of the venting cavities.

The device may be secured to the container in a temporary or permanent manner using any number of methods including but not limited to adhesives, friction fit, clips, and threaded attachment. In some embodiments of the present invention the exfiltration and venting cavities may be incorporated into the structure of a growing container.

Included as another aspect of the present invention is a method for removal of excess liquid from the exfiltration cavity via access through the venting cavity. This may be accomplished by inserting a hollow tube into the exfiltration cavity through the venting cavity and using suction to remove the excess liquid. In other embodiments, the hollow tube may be permanently incorporated into the device and suction is applied to the end of the tube that is located above the growing media. Liquid may also be removed from the exfiltration cavity by inserting and removing an absorbent material into the exfiltration cavity via the venting cavity.

### BRIEF DESCRIPTION OF THE DRAWINGS

FIG. 1A is a perspective view, and FIG. 1B is a partially transparent perspective view, and FIG. 1C is a section view, that together schematically illustrate an exemplary use of one embodiment of the present invention in a growing container. FIG. 1A includes demarcation indicating the plane upon which the section view of FIG. 1C is taken.

FIGS. 2A, and 2B are perspective views of one embodiment of the present invention, viewed upright and upside-down, respectively. FIGS. 2C, 2D, and 2E are side, front, and plan views, respectively, of said embodiment.

FIGS. 3A, and 3B are perspective views of another embodiment of the present invention, viewed upright and upside-down, respectively. FIG. 3C is a plan view of said embodiment, and FIG. 3D is a section view of said embodiment. FIG. 3C includes demarcation indicating the plane upon which the section view of FIG. 3D is taken.

FIG. 4A is a perspective view of another embodiment of the present invention, and 4B is an enlarged perspective view of a portion of said embodiment. FIG. 4C is a plan view of said embodiment, and

FIG. 4D is a section view of said embodiment. FIG. 4C includes demarcation indicating the plane upon which the section view of FIG. 4D is taken.

FIGS. 5A, and 5B are perspective views of another embodiment of the present invention, viewed upright and upside-down, respectively, and FIGS. 5C, 5D, and 5E are side, front, and plan views, respectively, of said embodiment.

FIG. 6A is a perspective view of another embodiment of the present invention, and FIG. 6B is a side view of said embodiment.

FIG. 7A is a perspective view of another embodiment of the present invention, and FIG. 7B is a side view of said embodiment.

FIGS. 8A, and 8B are perspective views of another embodiment of the present invention, and FIGS. 8C and 8D are side views of said embodiment.

FIG. 9A is a perspective view of another embodiment of the present invention, and FIG. 9B is an enlarged perspective view of a portion of said embodiment. FIGS. 9C, 9D, and 9E are side, front, and plan views, respectively, of said embodiment.

FIG. 10A is a perspective view of another embodiment of the present invention, 10B is an enlarged perspective view of a portion of said embodiment. FIGS. 10C, 10D, and 10E are side, front, and plan views, respectively, of said embodiment.

FIGS. 11A, and 11B are perspective views of another embodiment of the present invention, viewed upright and upside-down, respectively. FIG. 11C is a side view of said embodiment, and FIG. 11D is a plan view of said embodiment.

FIG. 12A is a perspective view, FIG. 12B is a perspective view with a cutaway portion, and FIG. 12C is a section view, that together schematically illustrate an exemplary use of another embodiment of the present invention. FIG. 12A includes demarcation indicating the plane upon which the section view of FIG. 12C is taken.

FIG. 13A is a perspective view, and FIG. 13B is a section view, that together schematically illustrate a method included as an aspect of the present invention. FIG. 13A includes demarcation indicating the plane upon which the section view of FIG. 13B is taken.

### DETAILED DESCRIPTION OF THE INVENTION

The following description and accompanying drawings provide exemplary illustrations of the best currently contemplated embodiments of the invention. The description is not to be taken in a limiting sense, but is made merely for the purpose of illustrating the general principles of the invention, since the scope of the invention is best defined by the appended claims.

Broadly, an embodiment of the present invention provides a device which can be used to create cavities within the growing media of plant containers, which by their design, prevent or mitigate the effects of too much liquid being applied to the growing media. The cavities generally fall into two categories: exfiltration cavities and venting cavities. The exfiltration cavities created by the device allow for the exfiltration of liquid from the growing media of a plant container into the cavity itself. The venting cavities provide a conduit for airflow between the exfiltration cavity and airspace above the growing media in the planting container, so as to facilitate evaporation of the liquid collected in the exfiltration cavity.

The present invention may be constructed from a variety of appropriate materials. Examples of such materials may include but are not limited to, plastics and bioplastics, metals, clays, ceramics, glass, and natural materials such as wood or plant-based products. The size of the present invention is not described since the invention may be scaled to various sizes so as to fit in plant containers of various sizes. Exemplary shapes of the present invention described and shown in accompanying drawings are chosen to communicate the general function of the present invention as described above, and alternate shapes maybe be utilized.

The First Embodiment described below communicates the general function of the present invention in its most basic form. Following the First Embodiment are Alternate Embodiments which are included in the present invention. The Alternate Embodiments may be implemented singularly or in different combinations.

### First Embodiment

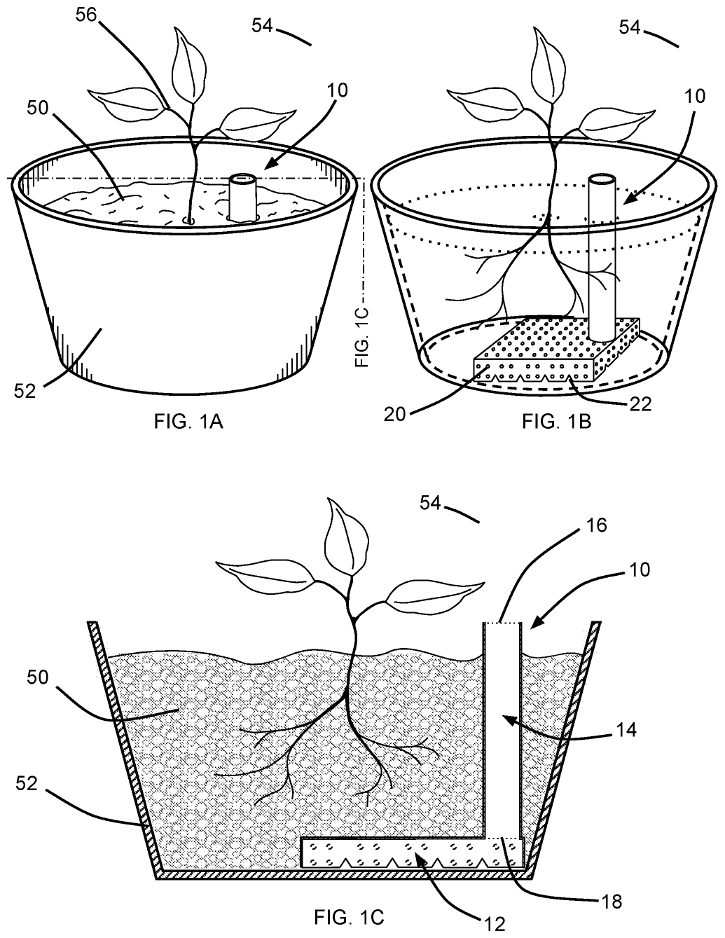

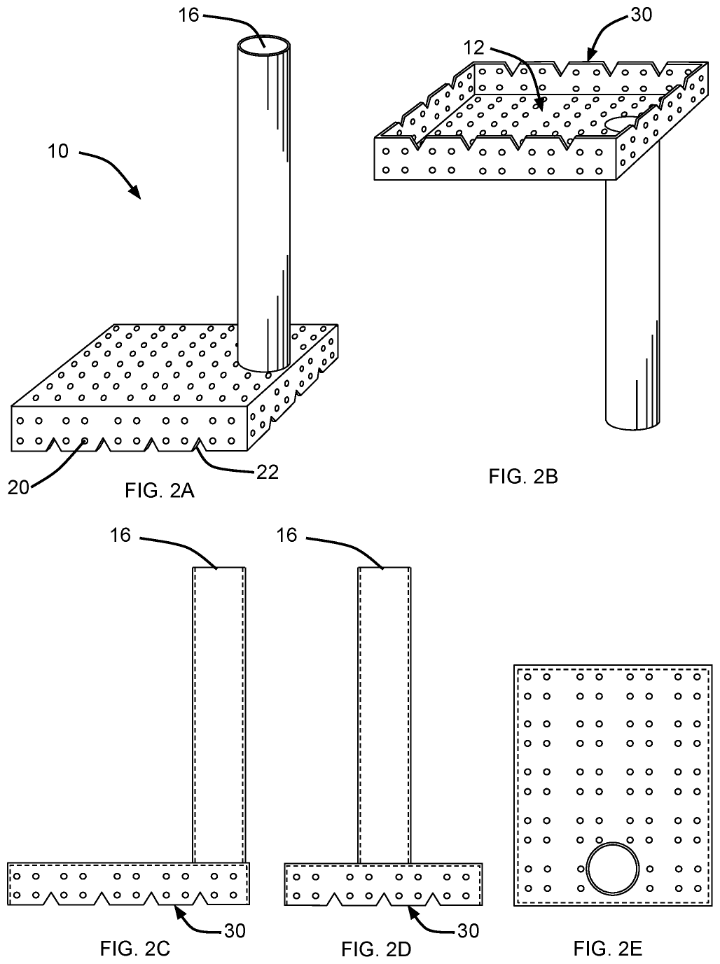

As seen in reference to FIG. 1A through FIG. 1C an embodiment of a device 10 to prevent or mitigate the effects of overwatering a plant 56 or plants according to the present invention is illustrated. A device 10 by way of its shape creates a hollow exfiltration cavity 12 extending between a lower and higher elevation within the growing media 50 and a hollow venting cavity 14 extending between a lower and higher elevation within the growing media 50 of a planting container 52. The venting cavity 14 incorporates one or more apertures 16 located at or near its highest elevation that enables airflow between the venting cavity 14 and the airspace 54 above the growing media 50. The venting cavity 14 has one or more apertures 18 located at or near its lowest elevation that connect to the exfiltration cavity 12 at or near its highest elevation to enable airflow between the venting cavity 14 and exfiltration cavity 12. The exfiltration cavity 12 incorporates one or more apertures 20 to enable any excess liquid which has been applied to the growing media 50 to drain into the exfiltration cavity 12. The exfiltration cavity 12 may also incorporate notches 22 at or near the lowest elevation of the exfiltration cavity 12 or where the exfiltration cavity 12 contacts the planting container 52. These notches 22 serve the same purpose as the apertures 20, in that they enable any excess liquid which has been applied to the growing media 50 to drain into the exfiltration cavity 12. As seen in reference to FIG. 2A through FIG. 2E, embodiments of the device 10, by way of its shape, may create an exfiltration cavity 12 that is open at the bottom 30.

### Alternate Embodiments

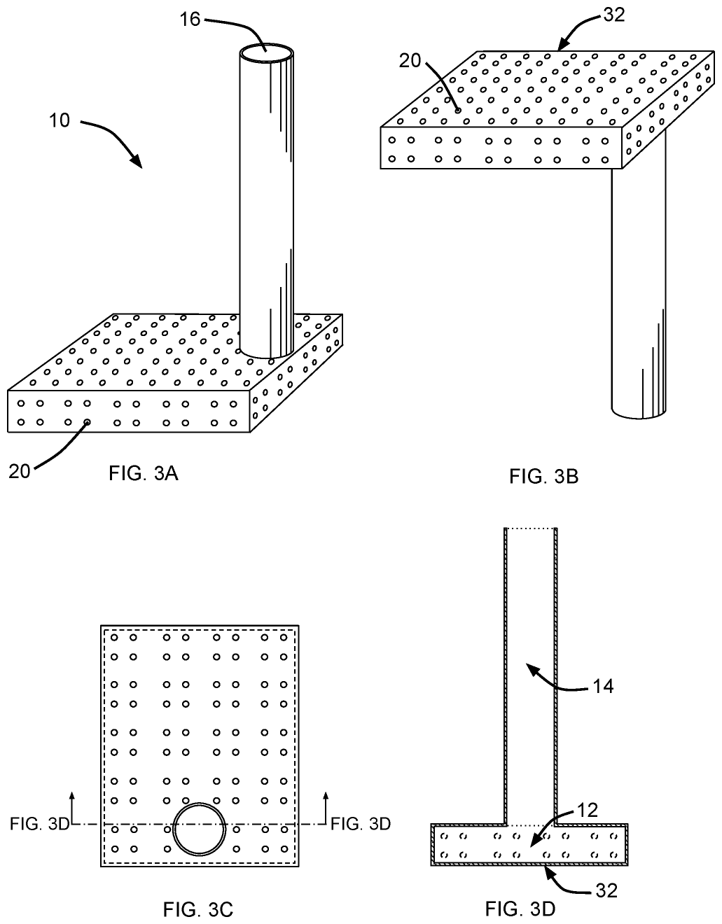

As seen in reference to FIG. 3A through FIG. 3E, embodiments of the device 10 may create exfiltration cavities 12 that are closed at the bottom 32 and which may contain one or more apertures 20. If the device 10 is installed in such a manner that the lowest elevation of the exfiltration cavity 12 does not contact the growing container 52 this can prevent the growing media 50 from entering the exfiltration cavity 12.

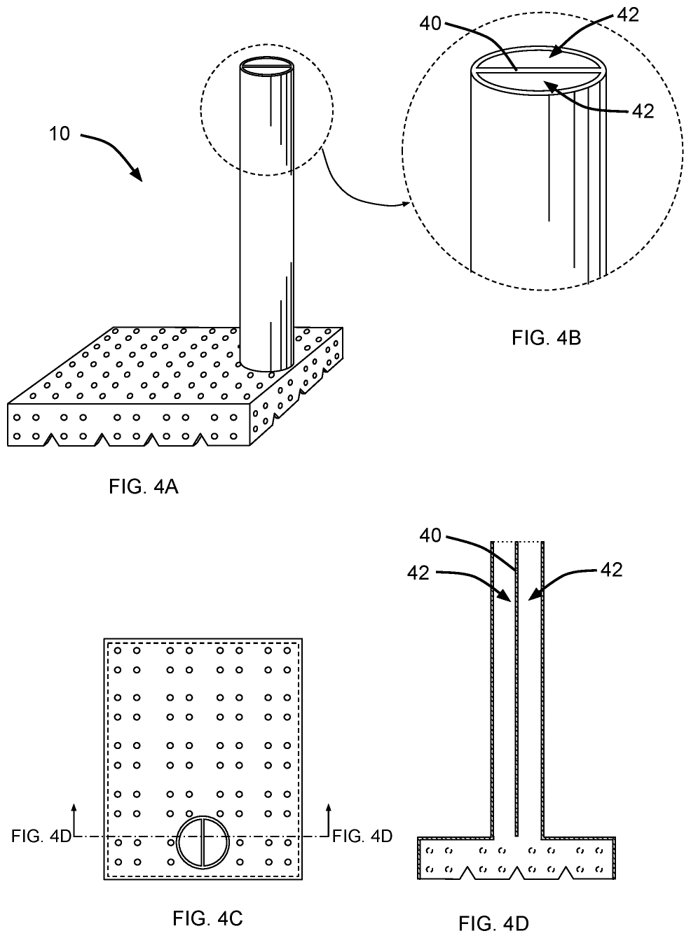

As seen in reference to FIG. 4A through FIG. 4D embodiments of the device 10 may incorporate one or more baffles 40 in the venting cavity 14 that separate the venting cavity 14 into two or more separate cavities 42 to produce separate cavities for inflow and outflow of air.

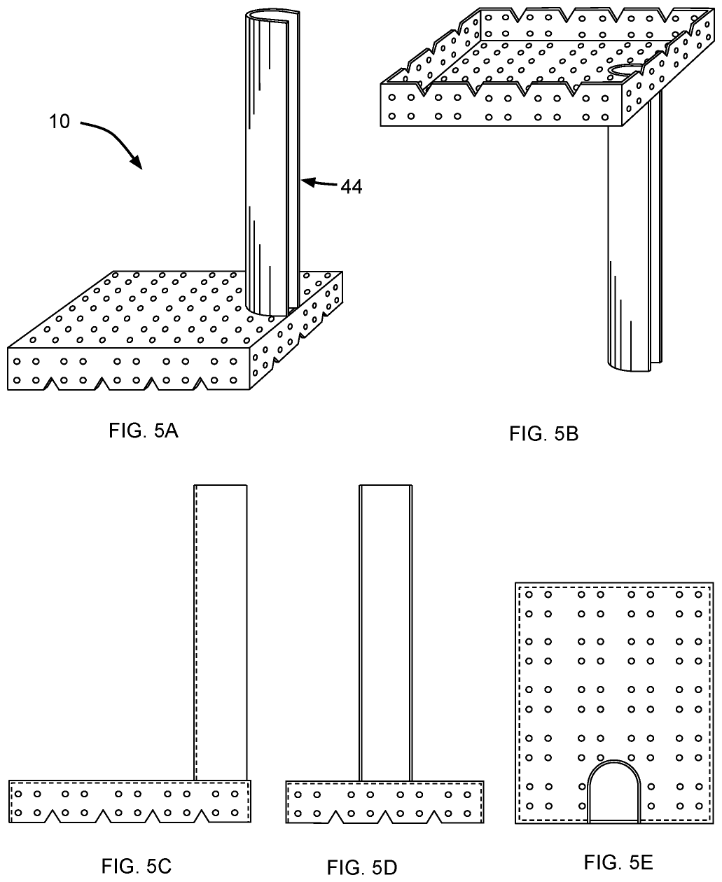

As seen in reference to FIG. 5A through FIG. 5E embodiments of the device 10 may incorporate a venting cavity 14 that is open on one side 44. The venting cavity may be made complete by contacting the open side 44 of the venting cavity 14 with the wall of the growing container 52.

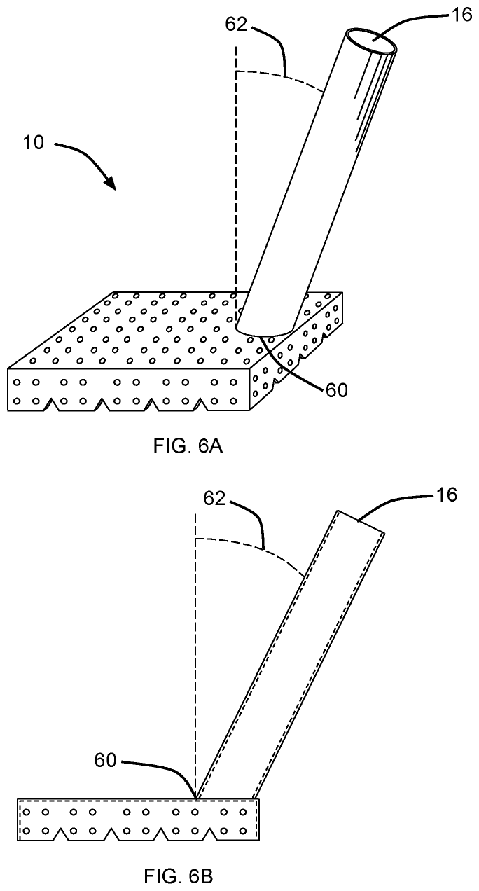

As seen in reference to FIG. 6A and FIG. 6B embodiments of the device 10 may incorporate a transition 60 from the exfiltration cavity 12 to the venting cavity 14 that can made at varying angles 62 so as to allow the aperture 16 located at or near the highest elevation of the venting cavity 14 to protrude from the growing media 50 at various locations within the growing container 52.

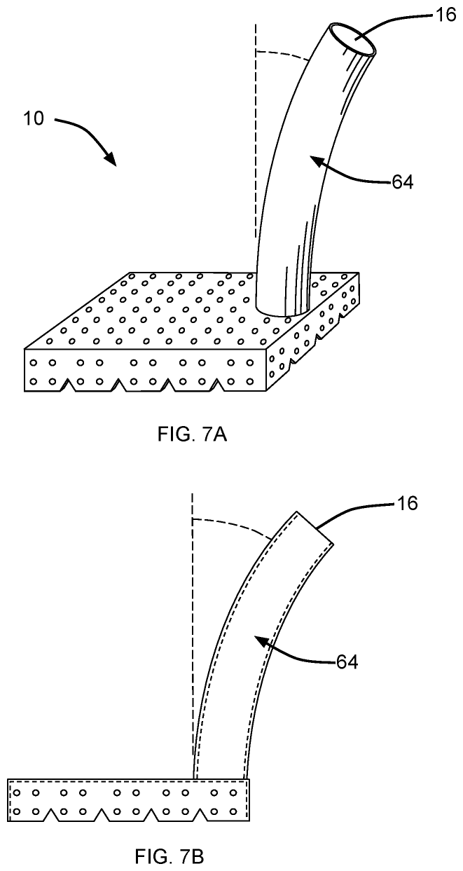

As seen in reference to FIG. 7A and FIG. 7B embodiments of the device 10 may incorporate a venting cavity 14 that can be made curved to varying extents 64 or is constructed from a flexible material so as to allow the aperture 16 located at or near the highest elevation of the venting cavity 14 to protrude from the growing media 50 at various locations within the growing container 52.

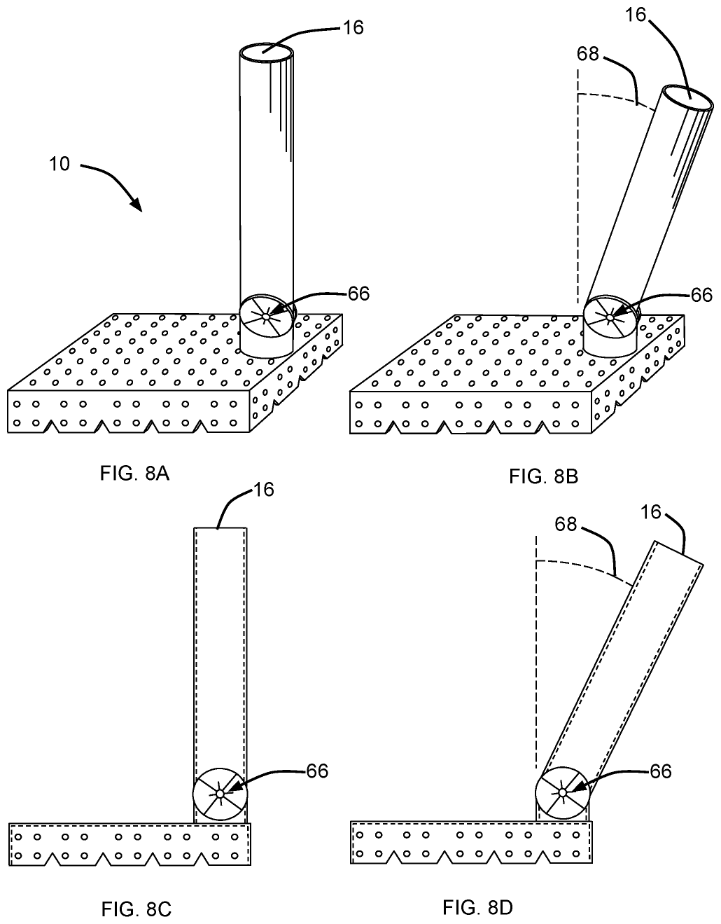

As seen in reference to FIG. 8A through FIG. 8D embodiments of the device 10 may incorporate an adjustable connector 66 at or near the transition from the venting cavity 14 to the exfiltration cavity 12 which allows the position of the venting cavity 14 to be made at varying angles 68 so as to allow the aperture 16 located at or near the highest elevation of the venting cavity 14 to protrude from the growing media 50 at various locations within the growing container 52.

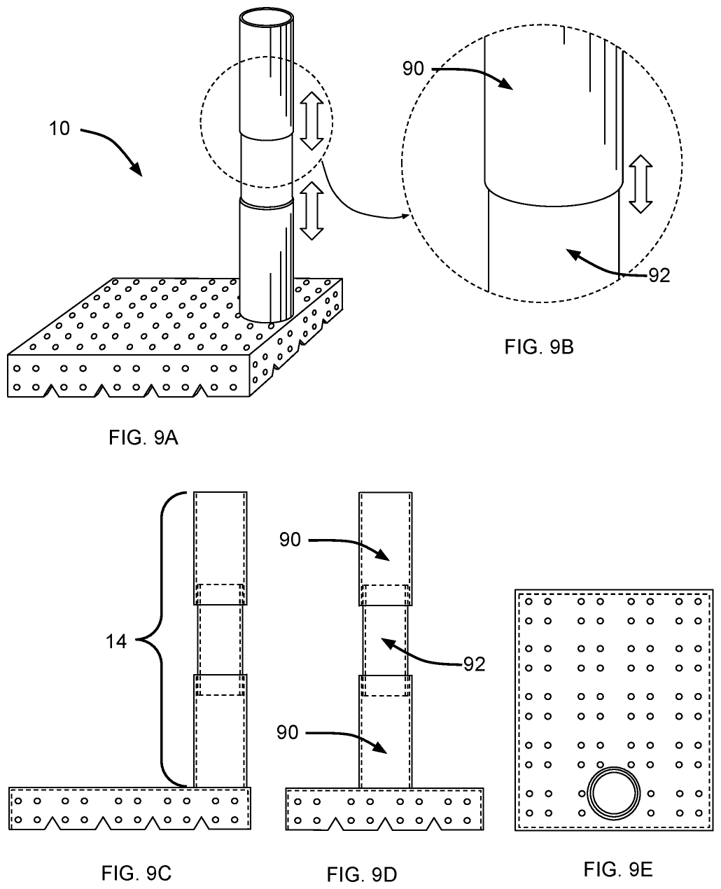

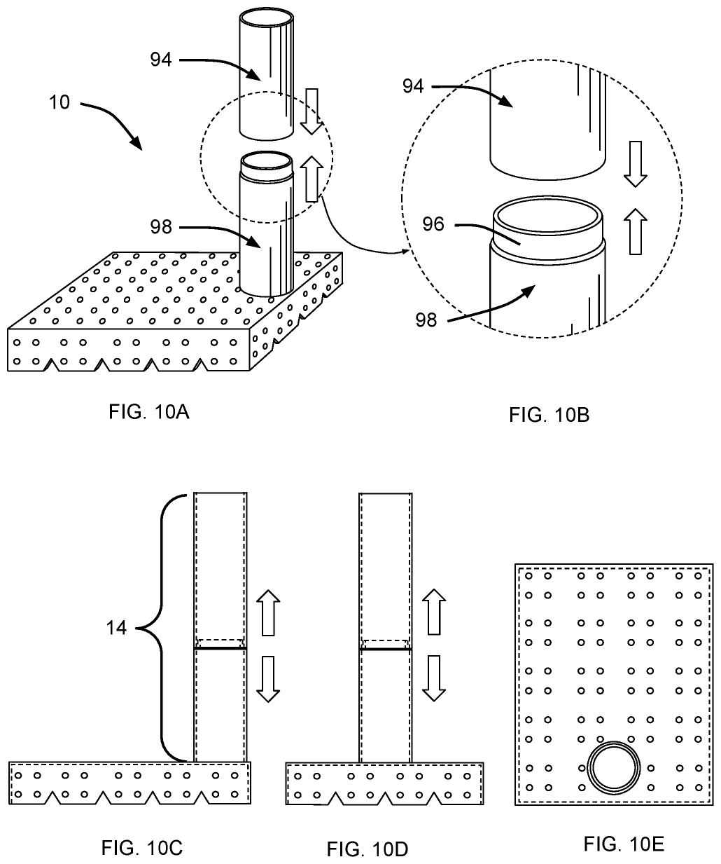

As seen in reference to FIG. 9A through FIG. 9E embodiments of the device 10 may incorporate a venting cavity 14 that can be made adjustable in length. This can be accomplished using various methods, and a few examples are provided for reference. As illustrated by the example shown in reference to FIG. 9 embodiments of the device 10 may incorporate a venting cavity 14 that consists of multiple concentric pieces with varied diameter wherein the smaller diameter pieces 92 may be placed within the larger diameter pieces 90 and the overlap between the two pieces may be adjusted to produce a venting cavity of various lengths. As illustrated by the example shown in reference to FIG. 10A through FIG. 10E the venting cavity 14 may consist of two or more pieces that can be used to adjust the length of the venting cavity 14 by stacking. Using this method, one piece 98 may incorporate a section of reduced diameter 96 at the highest elevation that can be inserted into the end of another piece 94.

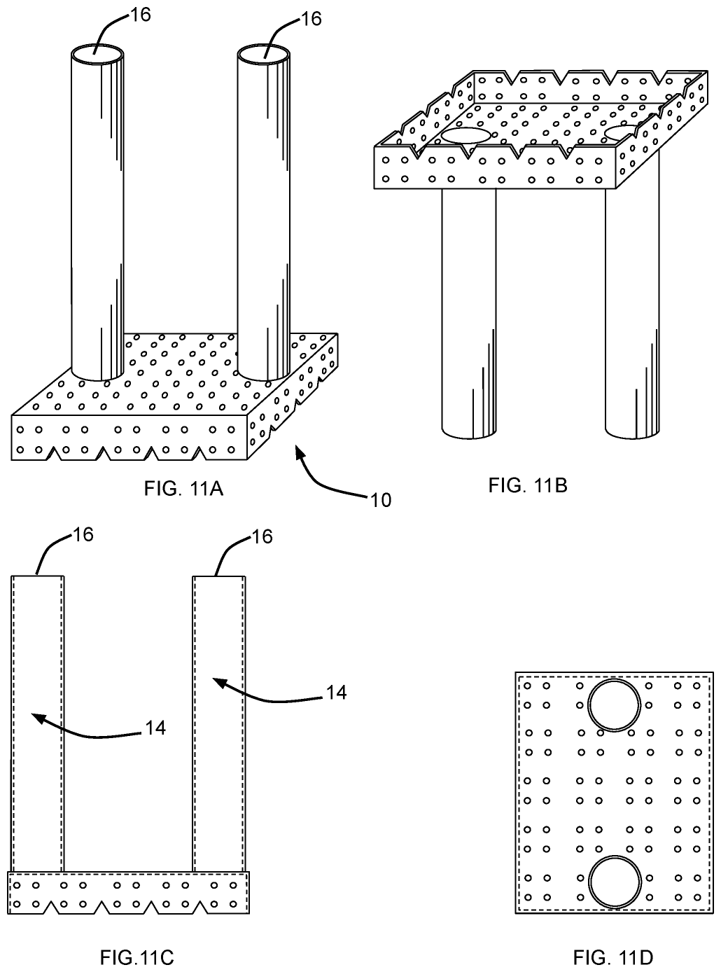

As seen in reference to FIG. 11A through FIG. 11D embodiments of the device 10 may incorporate more than one venting cavity 14. Each venting cavity 14 may have an aperture 16 located at or near the highest elevation of the venting cavity 14.

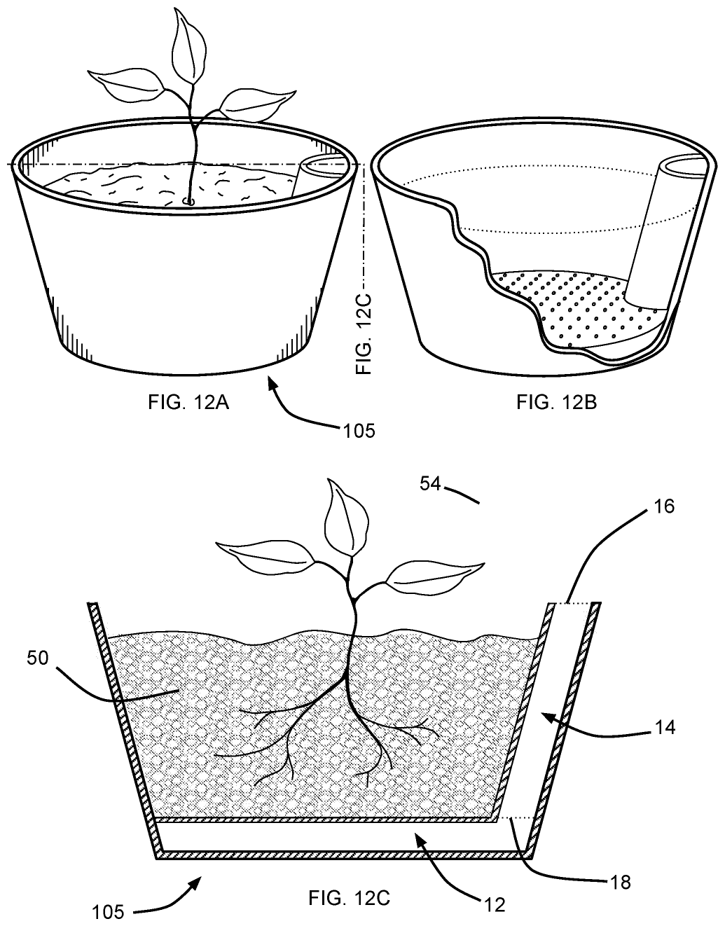

As seen in reference to FIG. 12A through FIG. 12C an alternate embodiment of the invention may consist of a planting container 105 wherein the exfiltration cavity 12 and venting cavity 14 are incorporated into the planting container 105.

### Method for Mechanically Removing Excess Fluid

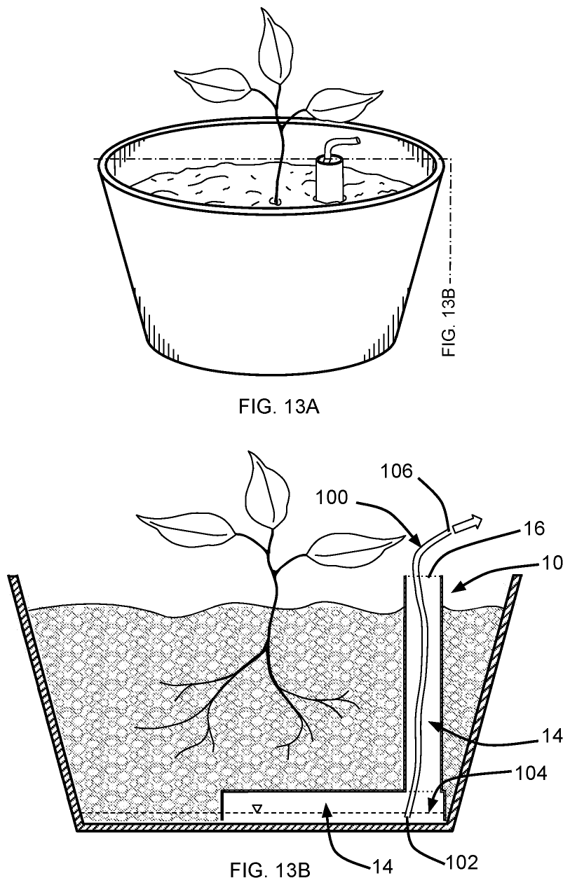

A seen in reference to FIG. 13A and FIG. 13B an exemplary illustration of a method that can be used to mechanically remove excess liquid from the present invention 10 is presented. To remove excess liquid a hollow tube 100 may be inserted into the device 10 via aperture 16 and lowered through the venting cavity 14 such that the aperture 102 on the hollow tube 100 may be submerged below the surface 104 of any excess liquid found within the exfiltration cavity 12. Any method of generating suction including but not limited to a syringe or pump may be used to apply a negative pressure to aperture 106 on the hollow tube 100 for a duration of time sufficient to remove the desired amount of liquid from the exfiltration cavity 12.

1. A device that can be placed in the growing media of a plant container to prevent or mitigate effects of over-watering of container-grown plants that: a. by way of its construction creates at least one hollow “exfiltration” cavity within the growing media that extends continuously between a lower elevation and a higher elevation that; i. incorporates one or more apertures which allow excess liquid applied to the growing media to flow into the lower portion of the hollow cavity (or cavities) so that said liquid may be removed through evaporation or mechanical removal; and ii. incorporates one or more apertures at or near the highest elevation of the cavity (or cavities); and b. by way of its construction creates at least one hollow “venting” cavity within the growing media that extends continuously between a lower elevation and a higher elevation that; i. at or near its lowest elevation connects to an aperture of the exfiltration cavity to allow for airflow between the cavities; and ii. at or near its highest elevation contains one or more apertures at or above the surface of the growing media to allow airflow between the external atmosphere and the cavities.

2. A device as in claim 1, where the bottom of the exfiltration cavity has an open bottom.

3. A device as in claim 1, wherein the bottom of the exfiltration cavity has a closed bottom which may contain one or more apertures to allow excess liquid applied to the growing media to flow into the lower portion of the hollow cavity.

4. A device as in claim 1, wherein the venting cavity contains one or more baffles that separate the venting cavity into multiple cavities so as to create separate inflow and outflow venting cavities.

5. A device as in claim 1, wherein the structure of the device's venting cavity is open on one or more sides and the complete hollow venting cavity is completed by incorporating the wall of the plant container.

6. A device as in claim 1, wherein the transition from the exfiltration cavity to the venting cavity is made at varying angles so as to allow the upper portion of the venting cavity to protrude at different locations of the surface of the growing media.

7. A device as in claim 1, wherein the venting cavity is curved to varying degrees or the venting cavity is made of a flexible material so as to allow the upper portion of the venting cavity to protrude at different locations of the surface of the growing media.

8. A device as in claim 1, wherein the transition from the exfiltration cavity to the venting cavity includes an adjustable connector that allows the venting cavity angle to be adjusted so as to allow the upper portion of the venting cavity to protrude at different locations of the surface of the growing media.

9. A device as in claim 1, wherein the venting cavity is made adjustable in length by consisting of two or more pieces that can be connected and disconnected or adjusted in a manner that changes the length using methods including but not limited to a telescoping manner.

10. A device as in claim 1, wherein one or more of the apertures on the exfiltration cavity may incorporate a filter material such as cloth or screening so as to prevent or reduce the ingress of growing media and plant roots into the exfiltration cavity.

11. A device as in claim 1, wherein mechanical ventilation may be used to augment air movement through the cavities using various methods, such as through the installation of an impeller in one or more of the cavities.

12. A device as in claim 1, wherein buoyancy driven ventilation may be used to augment air movement through the cavities using various methods, such as incorporation of a heating element into one or more of the venting cavities.

13. A device as in claim 1, wherein the invention is secured in a temporary or permanent manner to the plant container by way of methods including but not limited to adhesives, friction fit, clips, and threaded attachment.

14. A device as in claim 1, wherein the device is not insertable, but rather is a plant container in which the exfiltration cavity (or cavities) and venting cavity (or cavities) are wholly or partially incorporated into the plant container itself.

15. A method for mechanical removal of excess liquid from a device as in claim 1 through the insertion of a tube into the exfiltration cavity via the venting cavity and where the use of suction on said tube is used to remove the liquid.

16. A method as in claim 15, wherein the suction tube is permanently attached to, or incorporated in, a device as in claim 1 and suction is applied to said tube when removing excess liquid.

17. A method as in claim 15, wherein removing excess liquid from a device as in claim 1 is completed by way of an absorbent material being inserted into the hollow cavity, soaking up the excess liquid and then removed from the hollow cavity.
